(19) United States
(12) Patent Application Publication
(10) Pub. No.: US 2022/0200148 A1
(43) Pub. Date: Jun. 23, 2022

(54) QUADRUPLE-POLARIZED ANTENNA MODULE CAPABLE OF TIME-POLARIZATION ISOLATION

(71) Applicant: KMW INC., Hwaseong-si (KR)

(72) Inventors: Duk Yong KIM, Yongin-si (KR); Young Chan MOON, Suwon-si (KR); Sung Hwan SO, Hwaseong-si (KR); Oh Seog CHOI, Hwaseong-si (KR)

(73) Assignee: KMW INC., Hwaseong-si (KR)

(21) Appl. No.: 17/693,367

(22) Filed: Mar. 13, 2022

Related U.S. Application Data
(63) Continuation of application No. PCT/KR2020/012916, filed on Sep. 24, 2020.

(30) Foreign Application Priority Data
Sep. 27, 2019 (KR) 10-2019-0119933
Mar. 23, 2020 (KR) 10-2020-0034816

(51) Int. Cl. H01Q 5/28; H01Q 15/24; H01Q 21/24

(52) U.S. Cl. CPC H01Q 5/28; H01Q 21/24; H01Q 15/24

(57) ABSTRACT

A quad-polarized antenna module is provided for implementing temporal-polarization separation. The quad-polarized antenna module comprises a first radiating element module including a first radiating element and a second radiating element having a polarization direction orthogonal to a polarization direction of the first radiating element, and a second radiating element module including a third radiating element having a polarization direction difference of 45° with respect to the polarization direction of the first radiating element and a fourth radiating element having a polarization direction orthogonal to a polarization direction of the third radiating element The first radiating element module is connected to a transmission line and used to transmit a signal when the second radiating element module is connected to a reception line and used to receive a signal, and is connected to the reception line and used to receive a signal when the second radiating element module is connected to the transmission line and used to transmit a signal.

### CROSS-REFERENCE TO RELATED APPLICATIONS

This application is a continuation application of International Application No. PCT/KR2020/012916, filed Sep. 24, 2020, which claims priority to and benefit under 35 U.S.C § 119(a) of Korean Patent Application Nos. 10-2019-0119933 filed on Sep. 27, 2019 and 10-2020-0034816 filed on Mar. 23, 2020, the entire contents of which are incorporated herein by reference.

### TECHNICAL FIELD

The present disclosure relates to an antenna module, and more particularly, to a quad-polarized antenna module capable of implementing temporal-polarization separation and improving area efficiency of an antenna module.

### BACKGROUND

The contents described in this section merely provide background information for the present disclosure and do not constitute the related art.

A frequency-division duplex (FDD) scheme and a time-division duplex (TDD) scheme have been used as a method of sharing transmitted/received signals using a single transmission line or an antenna.

An example of a conventional antenna device for sharing transmitted/received signals using a TDD scheme is illustrated in FIG. 1.

The conventional TDD type antenna device may be configured to include an antenna (ANT), a filter, a switch (S/W), a power amplifier (PA), a low noise amplifier (LNA), an AD converter (not illustrated) and, a digital signal processor (FPGA, not illustrated), and the like.

The TDD type antenna (ANT) may have a form in which a plurality of antenna modules are arrayed, and the antenna module may include radiating elements (dual-polarized antenna module) having a form of a dual-polarized antenna.

As illustrated in FIG. 2, the dual-polarized antenna module may include two radiating elements that have different polarization directions (set in different polarization directions). Each arrow indicates a radiating element, a direction of the arrow indicates a polarization direction of each radiating element, and a dash-dotted line box indicates a region or a space occupied by the antenna module.

The dual-polarized antenna module performs a signal transmission function when the switch (S/W) is connected to a transmission line (Tx line), and performs a signal reception function when the switch (S/W) is connected to a reception line (Rx line). That is, the dual-polarized antenna module (furthermore, the conventional TDD type antenna device) may implement the TDD function by a selective switching operation of the switch (S/W).

However, signal loss may occur in the transmitted signal (downlink signal) or the received signal (uplink signal) through a switching process, and signal loss may also occur while the received signal is transmitted to a rear stage in the device through a cable. Such a signal loss may cause problems of deteriorating the noise figure (NF) and limiting an uplink coverage extension of a wireless communication system.

In order to solve the above problems, a new antenna module of the TDD type in which a transmitting antenna module (Tx antenna module) and a receiving antenna module (Rx antenna module) are physically separated has been recently introduced.

An example of a new antenna module is illustrated in FIG. 3. In FIG. 3, an antenna module located on a left side indicates transmitting antenna modules (T×1 and T×2), an antenna module located on a right side indicates receiving antenna modules (R×1 and R×2), and a dash-dotted line box indicates a region or a space occupied by the entire new antenna module. Since the transmitting and receiving antenna modules are physically separated (since the transmission line and the reception line are configured separately), the new antenna module may solve some of the problems caused by conventional switching.

However, the new antenna module is physically separated into two different components to transmit and receive signals, differently from the conventional antenna module that the signal transmission and reception are performed at a single antenna module. Accordingly, the new antenna module may cause a problem in that an area or a size of the antenna module itself increases.

In general, an antenna module array including a plurality of antenna modules is applied to an antenna device. The number of antenna modules included in the antenna module array is gradually increasing to implement multiple-input multiple-output (MIMO) technology. Therefore, when the area or size of the antenna module itself increases like the new antenna module, the entire area or size of the antenna device as well as the antenna module array increases, which may cause difficulties in a process of installation or maintenance of the antenna device as well as in a process of producing the antenna device.

### SUMMARY

### Technical Problem

An object of an embodiment of the present disclosure is to provide a quad-polarized antenna module capable of reducing an area of an antenna module by unifying dual-polarized antenna modules, and addressing signal loss caused from the switching by separating a transmitting antenna module and a receiving antenna module within the unified antenna module.

### Technical Solution

According to an embodiment of the present disclosure, there is provided a quad-polarized antenna module for implementing temporal-polarization separation, the quad-polarized antenna module including: a first radiating element module including a first radiating element and a second radiating element having a polarization direction orthogonal to a polarization direction of the first radiating element; and a second radiating element module including a third radiating element having a polarization direction difference of 45° with respect to the polarization direction of the first radiating element and a fourth radiating element having a polarization direction orthogonal to a polarization direction of the third radiating element, in which the first radiating element module is connected to a transmission line and used to transmit a signal when the second radiating element module is connected to a reception line and used to receive a signal, and is connected to the reception line and used to receive a signal when the second radiating element module is connected to the transmission line and used to transmit a signal.

### Advantageous Effects

As described above, according to the present disclosure, since a transmitting antenna module and a receiving antenna module are separated within a unified antenna module, signal loss caused by the switching can be reduced.

In addition, according to the present disclosure, since physically separated dual-polarized antenna modules are unified into one quad-polarized antenna module, it is possible to reduce an area as well as provide convenience in manufacturing, installation, maintenance, and the like.

### BRIEF DESCRIPTION OF THE DRAWINGS

FIG. 1 is a block diagram illustrating an example of a conventional antenna device.

FIGS. 2 and 3 are diagrams for describing a conventional antenna module.

FIG. 4 is a diagram for describing an example of separating temporal-polarization using the quad-polarized antenna module.

FIGS. 5 to 6 are diagrams for describing examples of the quad-polarized antenna module.

FIGS. 7 to 8 are diagrams for describing other examples of a quad-polarized antenna module.

FIG. 9 is a diagram for describing another example of a quad-polarized antenna module.

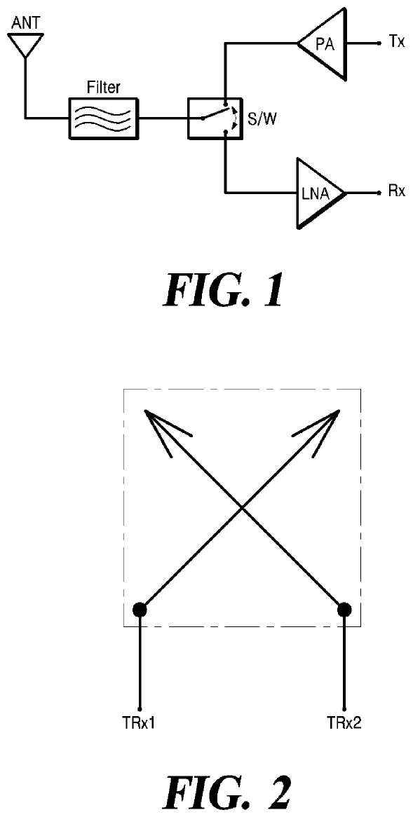

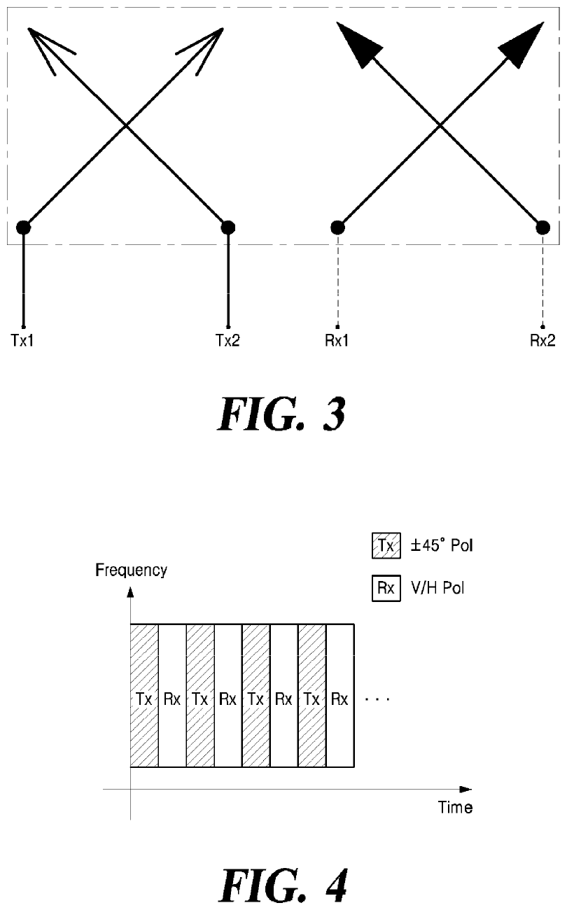

### DETAILED DESCRIPTION

Hereinafter, exemplary embodiments of the present disclosure will be described in detail with reference to the accompanying drawings. It is to be noted that in giving reference numerals to components of the accompanying drawings, the same components will be denoted by the same reference numerals even though they are illustrated in different drawings. Further, in describing exemplary embodiments of the present disclosure, well-known functions or configurations will not be described in detail since they may unnecessarily obscure the understanding of the present disclosure.

In addition, terms first, second, A, B, (a), (b), and the like, will be used in describing components of exemplary embodiments of the present disclosure. These terms are used only in order to distinguish any component from other components, and features, sequences, or the like, of corresponding components are not limited by these terms. Throughout the present specification, unless explicitly described to the contrary, “including” and “comprising” any components will be understood to imply the inclusion of other elements rather than the exclusion of any other elements. A term “unit,” “module,” or the like, described in the specification means a unit of processing at least one function or operation and may be implemented by hardware or software or a combination of hardware and software.

A quad-polarized antenna module 500 of the present disclosure corresponds to an antenna module capable of implementing temporal-polarization separation.

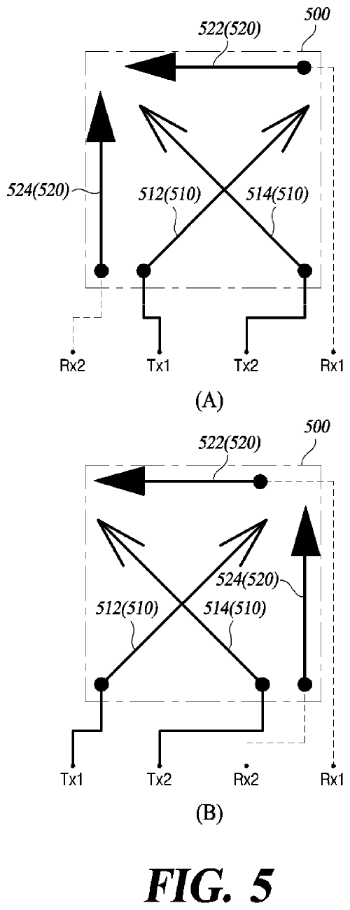

As illustrated in FIG. 5, the quad-polarized antenna module 500 may be configured to include a first radiating element module 510 and a second radiating element module 520.

The first radiating element module 510 may be configured to include two radiating elements 512 and 514 having polarization directions orthogonal or perpendicular to each other. The second radiating element module 520 may be configured to include two radiating elements 522 and 524 having polarization directions orthogonal or perpendicular to each other.

Here, the “orthogonal” or “perpendicular” may include both a case in which polarization directions of the radiating elements have an angle difference of exactly 90° and a case in which the polarization directions of the radiating elements have an angle difference of 90±θ. θ may vary depending on an error in a manufacturing process of the antenna module, a degree of correlation with other antenna modules, the need to adjust the beamforming direction, and the like.

One of the two radiating elements 510 and 512 included in the first radiating element module 510 is referred to as the first radiating element 512, and the other is referred to as the second radiating element 514. The second radiating element 514 may be set to have a polarization direction orthogonal or perpendicular to the polarization direction of the first radiating element 512.

One of the two radiating elements 522 and 524 included in the second radiating element module 520 is referred to as the third radiating element 522, and the other is referred to as the fourth radiating element 524. The third radiating element 522 may be set to have a difference in polarization direction of 45° with respect to the polarization direction of the first radiating element 512.

The fourth radiating element 524 may be set to have a polarization direction orthogonal or perpendicular to the polarization direction of the third radiating element 522. As described above, the second radiating element 514 has a polarization direction relationship of being orthogonal or perpendicular to the first radiating element 512, and the first radiating element 512 has a polarization direction relationship of 45° with respect to the third radiating element 522, and the fourth radiating element 524 has a polarization direction relationship of being orthogonal or perpendicular to the third radiating element 522. Accordingly, the fourth radiating element 524 has a polarization direction relationship of 45° with respect to the first radiating element 512 and the second radiating element 514.

Here, the “polarization direction relationship of 45°” may include both the case in which the radiating elements have a difference in polarization direction of exactly 45° and the case in which the radiating element haves a difference in polarization direction of 45°±θ. θ may vary depending on the error in the manufacturing process of the antenna module, the degree of correlation with other antenna modules, the need to adjust the beamforming direction, and the like.

According to the embodiment, the polarization direction of the radiating elements 512, 514, 522, and 524 may vary. For example, each of the first radiating element 512 and the second radiating element 514 may have polarization directions of +45° and −45°, and each of the third radiating element 522 and the fourth radiating element 524 may have vertical and horizontal polarizations. As another example, each of the first radiating element 512 and the second radiating element 514 may have vertical and horizontal polarization directions, and each of the third radiating element 522 and the fourth radiating element 524 may have polarization directions of +45° and −45°.

The first radiating element module 510 is connected to transmission lines Tx1 and Tx2 and used to transmit a signal, and the second radiating element module 520 is connected to reception lines Rx1 and Rx2 and used to receive a signal. Alternatively, the first radiating element module 510 is connected to the reception lines Rx1 and Rx2 and used to receive a signal, and the second radiating element module 520 is connected to the transmission lines Tx1 and Tx2 to and used to transmit a signal.

As described above, in the quad-polarized antenna module 500 of the present disclosure, since a radiating element module used to transmit a signal and a radiating element module used to receive a signal may be separated from each other, the problem (signal loss) of the related art caused by a switch operation can be solved.

In addition, since the quad-polarized antenna module 500 may use one of the first radiating element module 510 or the second radiating element module 520 for transmission and use the other of the first radiating element module 510 or the second radiating element module 520 for reception, temporal-polarization separation (signal transmission/reception and polarization separation) may be implemented.

An example of the temporal-polarization separation implemented using the quad-polarized antenna module 500 is illustrated in FIG. 4.

In FIG. 4, a hatched region Tx indicates a time period in which a signal is transmitted through the first radiating element module 510 used for transmission, and a non-hatched region Rx indicates a time period in which a signal is received through the second radiating element module 520 used for reception.

Here, the two radiating elements 512 and 514 in the first radiating element module 510 have polarization directions of ±45° (±45° Pol.), and the two radiating elements 522 and 524 in the second radiating element module 520 have a vertical polarization direction and a horizontal polarization direction (V/H Pol.).

Hereinafter, embodiments capable of improving the area efficiency of the quad-polarized antenna module 500 will be described. It is assumed that the first radiating element module 510 is connected to the transmission line and used to transmit a signal, and the second radiating element module 520 is connected to the reception line and used to receive a signal.

### First Embodiment

In a first embodiment, the third radiating element 522 and the fourth radiating element 524 are arranged around the first radiating element module 510. The first embodiment may be divided into the following sub-embodiments according to a location at which the third radiating element 522 is arranged and a location at which the fourth radiating element 524 is arranged.

### Embodiment 1-1

As illustrated in FIG. 5, the first radiating element 512 and the second radiating element 514 may have different polarization directions, which are orthogonal or perpendicular to each other. The first radiating element 512 and the second radiating element 514 may be connected to transmission lines Tx1 and Tx2 to be used for signal transmission.

The third radiating element 522 may be arranged on an upper side (around an upper side) of the first radiating element module 510. The third radiating element 522 arranged on the upper side of the first radiating element module 510 may have a difference in polarization direction of ±45° with respect to the first radiating element 512 and the second radiating element 514, and may be connected to a reception line Rx1 to be used for signal reception.

The fourth radiating element 524 may be arranged on a left side (around a left side) of the first radiating element module 510 (FIG. 5A), or arranged on a right side (around a right side) of the first radiating element module 510 (FIG. 5B). The fourth radiating element 524 arranged on the left side or the right side of the first radiating element module 510 may have a polarization direction which is orthogonal or perpendicular to the third radiating element 522, and have a polarization direction of ±45° with respect to the first radiating element 512 and the second radiating element 514. The fourth radiating element 524 may be connected to a reception line Rx2 and used to receive a signal.

### Embodiment 1-2

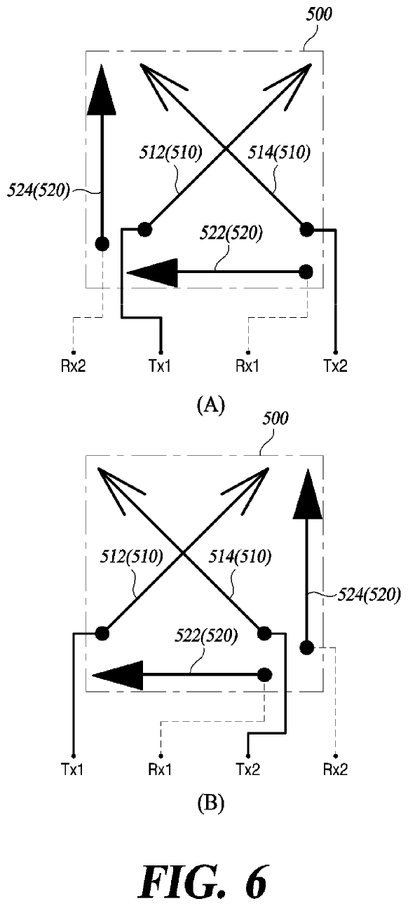

As illustrated in FIG. 6, the first radiating element 512 and the second radiating element 514 may have different polarization directions, which are orthogonal or perpendicular to each other. The first radiating element 512 and the second radiating element 514 may be connected to transmission lines Tx1 and Tx2 to be used for signal transmission.

The third radiating element 522 may be arranged on a lower side (around a lower side) of the first radiating element module 510. The third radiating element 522 arranged on the lower side of the first radiating element module 510 may have a difference in polarization direction of ±45° with respect to the first radiating element 512 and the second radiating element 514, and may be connected to the reception line Rx1 to be used for signal reception.

The fourth radiating element 524 may be arranged on a left side (around a left side) of the first radiating element module 510 (FIG. 6A), or arranged on a right side (around a right side) of the first radiating element module 510 (FIG. 6B). The fourth radiating element 524 arranged on the left side or the right side of the first radiating element module 510 may have a polarization direction which is orthogonal or perpendicular to the third radiating element 522, and have a polarization direction of ±45° with respect to the first radiating element 512 and the second radiating element 514. The fourth radiating element 524 may be connected to a reception line Rx2 and used to receive a signal.

As described in the first embodiment, the quad-polarized antenna module 500 of the present disclosure may be configured so that the third radiating element 522 and the fourth radiating element 524 may be arranged in a region (dash-dotted line box in FIGS. 5 and 6) occupied by the first radiating element module 510. As a result, more improved area efficiency may be provided compared to the conventional method in which the transmitting antenna module and the receiving antenna module are arranged in two physically separated regions. In addition, the improvement in area efficiency may lead to convenience in manufacturing, installation, maintenance, and the like.

In the first embodiment, the first radiating element 512 and the second radiating element 514 may be arranged in various forms. For example, the first radiating element 512 and the second radiating element 514 may be arranged to intersect with each other. In addition, centers of each of the first radiating element 512 and the second radiating element 514 may be arranged to coincide each other. In this case, the area of the region (dash-dotted line box in FIGS. 5 and 6) occupied by the first radiating element module 510 is minimized, and thus, the area efficiency of the entire quad-polarized antenna module 500 may be further increased.

### Second Embodiment

In a second embodiment, the first radiating element 512 and the second radiating element 514 are arranged around the second radiating element module 520. The second embodiment may be divided into the following sub-embodiments according to a location at which the first radiating element 512 is arranged and a location at which the second radiating element 514 is arranged.

### Embodiment 2-1

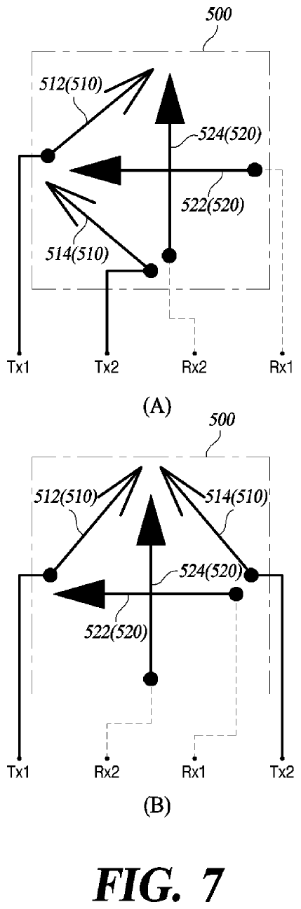

As illustrated in FIG. 7, the third radiating element 522 and the fourth radiating element 524 may have different polarization directions, which are orthogonal or perpendicular to each other. The third radiating element 522 and the fourth radiating element 524 may be connected to reception lines Rx1 and Rx2 to be used for signal reception.

The first radiating element 512 may be arranged on an upper left side (around an upper left side) of the second radiating element module 520. The first radiating element 512 arranged on the upper left side of the second radiating element module 520 has a difference in polarization direction of ±45° with respect to the third radiating element 522 and the fourth radiating element 524, and may be connected to a transmission line Tx1 and used to transmit a signal.

The second radiating element 514 may be arranged on a lower left side (around a lower left side) of the second radiating element module 520 (FIG. 7A), or arranged on an upper right side (around an upper right side) of the second radiating element module 520 (FIG. 7B). The second radiating element 514 arranged on the lower left side or the upper right side of the second radiating element module 520 may have a polarization direction which is orthogonal or perpendicular to the first radiating element 512, and have a difference in polarization direction of ±45° with respect to the third radiating element 522 and the fourth radiating element 524. The second radiating element 514 may be connected to a transmission line Tx2 and used to transmit a signal.

### Embodiment 2-2

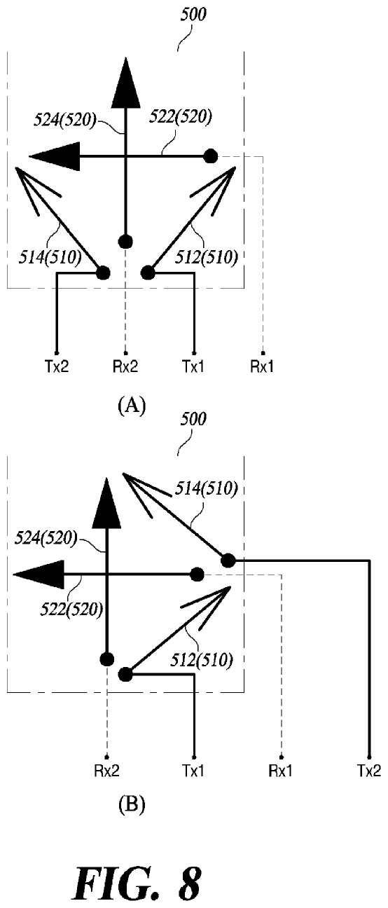

As illustrated in FIG. 8, the third radiating element 522 and the fourth radiating element 524 may have different polarization directions, which are orthogonal or perpendicular to each other. The third radiating element 522 and the fourth radiating element 524 may be connected to reception lines Rx1 and Rx2 to be used for signal reception.

The first radiating element 512 may be arranged on a lower right side (around a lower right side) of the second radiating element module 520. The first radiating element 512 arranged on the lower right side of the second radiating element module 520 has a difference in polarization direction of ±45° with respect to the third radiating element 522 and the fourth radiating element 524, and may be connected to a transmission line Tx1 to be used for signal transmission.

The second radiating element 514 may be arranged on a lower left side (around a lower left side) of the second radiating element module 520 (FIG. 8A), or arranged on an upper right side (around an upper right side) of the second radiating element module 520 (FIG. 8B). The second radiating element 514 arranged on the lower left side or the upper right side of the second radiating element module 520 may have a polarization direction which is orthogonal or perpendicular to the first radiating element 512, and have a difference in polarization direction of ±45° with respect to the third radiating element 522 and the fourth radiating element 524. The second radiating element 514 may be connected to a transmission line Tx2 and used to transmit a signal.

As described in the second embodiment, the quad-polarized antenna module 500 of the present disclosure may be configured so that the first radiating element 512 and the second radiating element 514 may be arranged in a region (dash-dotted line box in FIGS. 7 and 8) occupied by the second radiating element module 520. As a result, more improved area efficiency may be provided compared to conventional method in which the transmitting antenna module and the receiving antenna module are arranged in two physically separated regions. In addition, the improvement in area efficiency may lead to convenience in manufacturing, installation, maintenance, and the like.

In the second embodiment, the third radiating element 522 and the fourth radiating element 524 may be arranged in various forms. For example, the third radiating element 522 and the fourth radiating element 524 may be arranged to intersect each other. In addition, centers of each of the third radiating element 522 and the fourth radiating element 524 may be arranged to coincide with each other. In this case, the area of the region (dash-dotted line box in FIGS. 7 and 8) occupied by the second radiating element module 520 is minimized, and thus, area efficiency may be further increased.

### Third Embodiment

In a third embodiment, the first radiating element 512 and the second radiating element 514 are arranged to intersect each other, and the third radiating element 522 and the fourth radiating element 524 are also arranged to intersect each other.

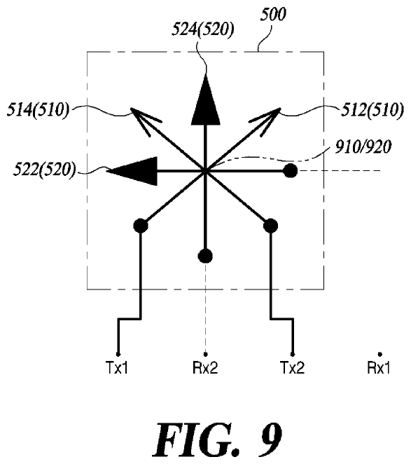

As illustrated in FIG. 9, the first radiating element 512 and the second radiating element 514 may be arranged to intersect each other. A location or point at which the first radiating element 512 and the second radiating element 514 intersect each other is referred to as a “first intersection point 910.” In addition, the first radiating element 512 and the second radiating element 514 may have different polarization directions, which are orthogonal or perpendicular to each other, and may be connected to the transmission lines Tx1 and Tx2 to be used for signal transmission.

As illustrated in FIG. 9, the third radiating element 522 and the fourth radiating element 524 may be arranged to intersect each other. A location or point at which the third radiating element 522 and the fourth radiating element 524 intersect each other is referred to as a “second intersection point 920.” In addition, the third radiating element 522 and the fourth radiating element 524 may have different polarization directions, which are orthogonal or perpendicular to each other, and may be connected to the reception lines Rx1 and Rx2 to be used for signal reception.

An area (dash-dotted line box in FIG. 9) occupied by the quad-polarized antenna module 500 may be determined according to a distance between the first intersection point 910 and the second intersection point 920. As the distance between the first intersection point 910 and the second intersection point 920 increases, the area occupied by the quad-polarized antenna module 500 may increase, and as the distance between the first intersection point 910 and the second intersection point 920 decreases, the area occupied by the quad polarization antenna module 500 may decrease.

In order to provide more improved area efficiency compared to the conventional method (the transmitting antenna module and the receiving antenna module are arranged in two physically separated areas), the distance between the first intersection point 910 and the second intersection point 920 is preferably less than or equal to a length of one radiating element.

In a range of a distance less than or equal to the length of one radiating element, the distance between the first intersection point 910 and the second intersection point 920 may be variously set according to a designer's intention or an arrangement relationship with other antenna modules constituting the antenna module array.

When the distance between the first intersection point 910 and the second intersection point 920 is minimized, the efficiency of the area occupied by the quad-polarized antenna module 500 may be maximized. Therefore, in order to maximize area efficiency, the first intersection point 910 and the second intersection point 920 may be arranged at the same location. That is, the area efficiency may be maximized when: the first radiating element 512 and the second radiating element 514 are arranged so that the centers of each of the first radiating element 512 and the second radiating element 514 coincide each other (at the first intersection point), the third radiating element 522 and the fourth radiating element 524 are also arranged so that the centers of each of the third radiating element 522 and the fourth radiating element 524 coincide each other (at the second intersection point), and the first intersection point 910 and the second intersection point 920 are arranged at the same location.

The spirit of the present embodiments is illustratively described hereinabove. It will be appreciated by those skilled in the art that various modifications and alterations may be made without departing from the essential characteristics of the present embodiments. Accordingly, exemplary embodiments disclosed in the present disclosure are not intended to limit the spirit of the present disclosure, but to describe the spirit of the present disclosure. The scope of the present embodiments is not limited to these exemplary embodiments. The scope of the present embodiments should be interpreted by the following claims, and it should be interpreted that all technical ideas equivalent to the following claims fall within the scope of the present embodiments.

1. A quad-polarized antenna module for implementing temporal-polarization separation, the quad-polarized antenna module comprising:
a first radiating element module including a first radiating element and a second radiating element having a polarization direction orthogonal to a polarization direction of the first radiating element; and
a second radiating element module including a third radiating element having a polarization direction difference of 45° with respect to the polarization direction of the first radiating element and a fourth radiating element having a polarization direction orthogonal to a polarization direction of the third radiating element,
wherein the first radiating element module is connected to a transmission line and used to transmit a signal when the second radiating element module is connected to a reception line and used to receive a signal, and is connected to the reception line and used to receive a signal when the second radiating element module is connected to the transmission line and used to transmit a signal.

2. The quad-polarized antenna module of claim 1, wherein the third radiating element is arranged on an upper side of the first radiating element module, and
the fourth radiating element is arranged on a left side or a right side of the first radiating element module.

3. The quad-polarized antenna module of claim 1, wherein the third radiating element is arranged on a lower side of the first radiating element module, and
the fourth radiating element is arranged on a right side or a left side of the first radiating element module.

4. The quad-polarized antenna module of claim 2,
wherein centers of each of the first radiating element and the second radiating element are arranged to coincide each other.

5. The quad-polarized antenna module of claim 1, wherein the first radiating element is arranged on an upper left side of the second radiating element module, and
the second radiating element is arranged on a lower left side or an upper right side of the second radiating element module.

6. The quad-polarized antenna module of claim 1, wherein the first radiating element is arranged on a lower right side of the second radiating element module, and
the second radiating element is arranged on an upper right side or a lower left side of the second radiating element module.

7. The quad-polarized antenna module of claim 5,
wherein centers of each of the third radiating element and the fourth radiating element are arranged to coincide each other.

8. The quad-polarized antenna module of claim 1, wherein the first radiating element is arranged to intersect with the second radiating elements at a first intersection point, and
the third radiating element is arranged to intersect with the fourth radiating element at a second intersection point.

9. The quad-polarized antenna module of claim 8, wherein the first intersection point is arranged at the same location as the second intersection point.

10. The quad-polarized antenna module of claim 3, wherein centers of each of the first radiating element and the second radiating element are arranged to coincide each other.

11. The quad-polarized antenna module of claim 6, wherein centers of each of the third radiating element and the fourth radiating element are arranged to coincide each other.
